(19) United States
(12) Patent Application Publication
(10) Pub. No.: US 2012/0114934 A1
(43) Pub. Date: May 10, 2012

(54) BONDING SHEET

(76) Inventors: Megumi Kodama, Chiba (JP); Takahiro Tokuyasu, Chiba (JP); Tetsurou Iwakura, Ibaraki (JP)

(21) Appl. No.: 13/319,845

(22) PCT Filed: May 11, 2010
(86) PCT No.: PCT/JP2010/057965

§ 371 Date: Jan. 6, 2012

(30) Foreign Application Priority Data
May 13, 2009 (JP) 2009-116439
Oct. 6, 2009 (JP) 2009-232497

(51) Int. Cl. B32B 3/00; B32B 7/12

(52) U.S. Cl. 428/336; 428/343

(57) ABSTRACT

The present invention relates to a bonding sheet including: an adhesive layer of an adhesive composition having a high-molecular weight component (A) and a thermosetting component (B) formed into a sheet, wherein a ratio (P_{CN}/P_{CO}) of a peak height near 2240 cm⁻¹ derived from a nitrile group (P_{CN}) to a peak height near 1730 cm⁻¹ derived from a carbonyl group (P_{CO}) is 0.03 or less in an IR spectrum of the high-molecular weight component (A).

### TECHNICAL FIELD

The present invention relates to a bonding sheet.

### BACKGROUND ART

In recent years, a stacked MCP (Multi Chip Package) in which multiple memory package chips for cellular phones and portable audio equiμment are stacked has been spread. For such a package, it is one of the challenges for the improvement of connection reliability to mount the chips without producing voids on the bonding surface of the chips. Particularly, when the chips are stacked on a substrate having wiring and the like, embedding properties for sufficiently embedding unevenness of the substrate surface is important for insuring the connection reliability of the package. On the other hand, a substrate and a wafer are being reduced in thickness with the recent reduction in size and thickness of semiconductor devices, leading to a tendency of easily producing a warpage or the like of an element caused by thermal stress as mentioned above. Therefore, mounting at a lower temperature and under a lower load is strongly required.

However, since it is difficult to sufficiently embed the above unevenness only by low temperature and low load compression mounting, a method in which a chip provided with a bonding sheet is fixed on a substrate by thermocompression bonding and the unevenness is embedded by heat and pressure in a package sealing step has conventionally been mainstream. Examples of known bonding sheets which can ensure such embedding properties include bonding films containing an epoxy resin, a phenol resin, and an acrylic copolymer as described in Patent Literature 1.

### CITATION LIST

### Patent Literature

Patent Literature 1: JP 2002-220576 A

### SUMMARY OF INVENTION

### Technical Problem

However, due to finer wiring accompanying the reduction in size and thickness of semiconductor devices and use of a corrosion-prone metal such as copper along with the requirements of cost reduction and enhanced speed of semiconductor devices in recent years, insulation properties are reduced and the connection reliability of semiconductor devices is reduced. Therefore, improvement in not only embedding properties but also insulation properties has been important challenges for ensuring connection reliability, and a bonding sheet which can satisfy both embedding properties and insulation properties is required.

Thus, an object of the present invention is to provide a bonding sheet which is excellent in embedding properties and insulation properties and allows improvement in the connection reliability of semiconductor devices.

### Solution to Problem

The present invention provides a bonding sheet comprising: an adhesive layer of an adhesive composition including a high-molecular weight component (A) and a thermosetting component (B) formed into a sheet, wherein a ratio (P_{CN}/P_{CO}) of a peak height near 2240 cm⁻¹ derived from a nitrile group (P_{CN}) to a peak height near 1730 cm⁻¹ derived from a carbonyl group (P_{CO}) is 0.03 or less in an IR spectrum of the high-molecular weight component (A).

In the present invention, the nitrile group content in the high-molecular weight component (A) is represented by the ratio of the peak height of a nitrile group to the peak height of a carbonyl group in the IR spectrum. The bonding sheet of the present invention is sufficiently excellent in embedding properties and insulation properties and can be improved in the connection reliability of semiconductor devices by reducing the nitrile group content in the high-molecular weight component (A) to a predetermined amount or less.

Further, the nitrogen content of the above high-molecular weight component (A) is preferably 4.0% by mass or less in accordance with elementary analysis.

In the above bonding sheet, the melt viscosity at 100° C. of the adhesive layer is preferably 300 to 30000 Pa·s and the thickness of the adhesive layer is preferably 3 to 250 μm. Thereby, the embedding properties of the adhesive layer can be further secured.

When the above adhesive composition further contains a filler (C), a curing accelerator (D), and a coupling agent (E), the bonding sheet of the present invention will be more excellent in reliability.

### Advantageous Effects of Invention

The present invention can provide a bonding sheet which is excellent in embedding properties allowing embedding the unevenness of a substrate or a semiconductor chip and insulation properties posing problems in terms of the finer wiring and the use of corrosion-prone copper wiring or the like and which allows improvement in the connection reliability of semiconductor devices.

### BRIEF DESCRIPTION OF DRAWINGS

FIG. 1 is a schematic cross section showing one preferred embodiment of the bonding sheet of the present invention.

### DESCRIPTION OF EMBODIMENTS

Hereinafter, the preferred embodiments of the present invention will be described in detail, referring to the drawing if necessary. Note that, in the drawings, the same reference signs will be used for the same or corresponding part, and the overlapping description will be omitted. Note that the proportion of the sizes in each drawing includes a part exaggerated for description and will not necessarily reflect the true proportion.

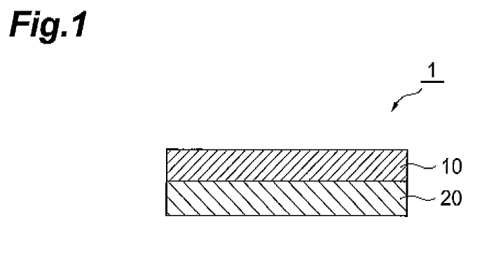

FIG. 1 is a schematic cross section showing one preferred embodiment of the bonding sheet of the present invention. The bonding sheet 1 shown in FIG. 1 comprises a base film 20 and an, adhesive layer 10 provided on the base film 20. The adhesive layer 10 is made of the adhesive composition according to the present invention. With respect to the bonding sheet of the present invention, the surface of the adhesive layer 10 on the opposite side of the base film 20 may be coated with a protective film.

The bonding sheet of the present invention is a bonding sheet comprising an adhesive layer of an adhesive composition including a high-molecular weight component (A) and a thermosetting component (B) formed into a sheet, and is characterized in that, a ratio (P_{CN}/P_{CO}) of a peak height near 2240 cm⁻¹ derived from a nitrile group (P_{CN}) to a peak height near 1730 cm⁻¹ derived from a carbonyl group (P_{CO}) is 0.03 or less in an IR spectrum of the high-molecular weight component (A).

First, each component which constitutes the adhesive composition according to the present invention will be described in detail.

High-Molecular Weight Component (A)

The high-molecular weight component (A) includes polyimide resins, (meth)acrylic resins, urethane resins, polyphenylene ether resins, polyetherimide resins, phenoxy resins, and modified polyphenylene ether resins, which have a crosslinkable functional group such as an epoxy group, an alcoholic hydroxyl group, a phenolic hydroxyl group, and a carboxyl group. These resins are preferably sufficiently reduced in the content nitrile group, and more preferably have no nitrile group.

In terms of film formability (toughness), as the high-molecular weight component (A) used in the present invention, an epoxy group-containing (meth)acrylic copolymer obtained by polymerizing a monomer containing a functional monomer such as glycidyl acrylate or glycidyl methacrylate or the like is preferable. Further, a (meth)acrylate copolymer, acrylic rubber, and the like can be used as the (meth)acrylic copolymer, and an acrylate copolymer is more preferred. Here, the acrylic rubber is a rubber which contains an acrylate as the main component and is composed primarily of a copolymer of butyl acrylate, acrylonitrile and the like and a copolymer of ethyl acrylate, acrylonitrile and the like. When the acrylic rubber is used in the present embodiment, it is necessary to use the rubber in which the proportion of acrylonitrile is sufficiently reduced or the rubber which contains no acrylonitrile.

When the epoxy group-containing (meth)acrylic copolymer contains acrylonitrile as a monomer unit, the content of acrylonitrile is preferably 10% by mass or less on the basis of the total mass of the monomers which constitute the epoxy group-containing (meth)acrylic copolymer.

The amount of a nitrile group in the high-molecular weight component (A) can be determined by IR measurement and elementary analysis.

In the IR spectrum of the high-molecular weight component (A), a ratio (P_{CN}/P_{CO}) of a peak height near 2240 cm⁻¹ derived from a nitrile group (P_{CN}) to a peak height near 1730 cm⁻¹ derived from a carbonyl group (P_{CO}) is preferably 0.03 or less.

The nitrogen content of the high-molecular weight component (A) measured in accordance with the elementary analysis is preferably 4.0% by mass or less, more preferably 3.0% by mass or less.

The glass transition temperature (hereinafter written as “Tg”) of the high-molecular weight component (A) is preferably −50 to 50° C., more preferably −30 to 20° C. If the Tg of the high-molecular weight component is less than −50° C., a tacking force after film formation can be increased, and conversely, if it exceeds 50° C., fluidity can be impaired.

The weight average molecular weight (hereinafter written as “Mw”) of the high-molecular weight component is, but is not limited to, preferably 50,000 to 1,200,000, more preferably 100,000 to 1,200,000, further preferably 200,000 to 600,000. If the Mw of the high-molecular weight component is less than 50,000, film formability will tend to be reduced, and conversely, if it exceeds 1,200,000, fluidity will tend to be reduced. Note that Mw means a value obtained by measurement by gel permeation chromatography (GPC) and conversion using a calibration curve with standard polystyrene.

Examples of the high-molecular weight component (A) which satisfies the above description include epoxy group-containing acrylic random copolymers in which glycidyl methacrylate, which is a functional monomer, is copolymerized with methyl methacrylate, ethyl methacrylate, ethyl acrylate and butyl acrylate.

Thermosetting Component (B)

The thermosetting component (B) is a component comprising a reactive compound which may cause crosslinking reaction with heat. Examples of the thermosetting component include an epoxy resin, a bismaleimide resin, a phenol resin, a urea resin, a melamine resin, an alkyd resin, an acrylic resin, an unsaturated polyester resin, a diallyl phthalate resin, a silicone resin, a resorcinol formaldehyde resin, a xylene resin, a furan resin, a polyurethane resin, a ketone resin, a triallyl cyanurate resin, a polyisocyanate resin, a resin containing tris(2-hydroxyethyl)isocyanurate, a resin containing triallyl trimellitate, a thermosetting resin synthesized from cyclopentadiene, and a thermosetting resin prepared by trimerization of an aromatic dicyanamide. Among them, an epoxy resin, a cyanate resin, and a bismaleimide resin are preferred in that they can have excellent adhesive strength at high temperatures. As the thermosetting resin, it is possible to suitably use an epoxy resin which has heat resistance and moisture resistance required for mounting semiconductor devices and reacts at 150° C. or higher to attain high molecular weight. Such a thermosetting component can be used independently or in combination of two or more.

The epoxy resin is not particularly limited as long as it is cured to obtain a product having adhesive action. Examples of the applicable epoxy resins include those generally known such as a Bifunctional epoxy resin such as a bisphenol A type epoxy resin, a bisphenol F type epoxy resin, and a bisphenol S type epoxy resin; a novolac type epoxy resin such as a phenol novolac type epoxy resin and a cresol novolac type epoxy resin; a polyfunctional epoxy resin; and an alicyclic epoxy resin. Among them, a bisphenol F type epoxy resin, a cresol novolac type epoxy resin and the like are preferred. These can be used independently or in combination of two or more.

When the epoxy resin as described above is used, the thermosetting component preferably contains a curing agent for curing the epoxy resin. A known curing agent which has been conventionally used can be used as a curing agent. Examples of the curing agent include a phenol-based compound, an aliphatic amine, an alicyclic amine, an aromatic polyamine, a polyamide, an aliphatic acid anhydride, an alicyclic acid anhydride, an aromatic acid anhydride, a dicyandiamide, an organic acid dihydrazide, a boron trifluoride amine complex, imidazoles, and a tertiary amine. Among them, a phenol-based compound is preferred, and a phenol-based compound having at least two or more phenolic hydroxyl groups in a molecule is more preferred. Examples of such a compound include phenol novolac, cresol novolac, t-butylphenol novolac, dicyclopentadiene cresol novolac, dicyclopentadiene phenol novolac, xylylene-modified phenol novolac, a naphthol-based compound, a trisphenol-based compound, tetrakis phenol novolac, bisphenol A novolac, poly-p-vinylphenol, and a phenol aralkyl resin. Among them, a preferred curing agent includes a phenol-based compound having two or more phenolic hydroxyl groups in a molecule such as bisphenol A, bisphenol F, and bisphenol S and a phenol resin such as a phenol novolac resin, a bisphenol A novolac resin, or a cresol novolac resin. These can be used independently or in combination of two or more.

Filler (C)

A filler (C) can also be added to the adhesive composition in addition to the above components. The filler (C) is not particularly limited, but an inorganic filler is preferred, and examples of the filler (C) which can be used include aluminum hydroxide, magnesium hydroxide, calcium carbonate, magnesium carbonate, calcium silicate, magnesium silicate, calcium oxide, magnesium oxide, alumina, aluminum nitride, an aluminum borate whisker, boron nitride, crystalline silica, and amorphous silica. These can be used independently or in combination of two or more.

It is preferred to use alumina, aluminum nitride, boron nitride, crystalline silica, or amorphous silica as a filler from the point of view of improving thermal conductivity. Further, in terms of adjusting melt viscosity or imparting thixotropy, it is preferred to use aluminum hydroxide, magnesium hydroxide, calcium carbonate, magnesium carbonate, calcium silicate, magnesium silicate, calcium oxide, magnesium oxide, alumina, crystalline silica, or amorphous silica. Further, it is preferred to use alumina or silica from the point of view of improving dicing properties.

The average particle size of the filler is preferably 0.005 to 2.0 μm. If the average particle size is less than 0.005 μm, or if it exceeds 2.0 μm, the adhesiveness of a bonding sheet may be reduced. In order to obtain good film formability and high adhesive strength of the adhesive composition, the average particle size of the filler is preferably 0.005 to 1.5 μm, more preferably 0.005 to 1.0 μm.

The content proportion of the filler is preferably 1 to 10 parts by mass, more preferably 3 to 5 parts by mass, based on 100 parts by mass of the sum of the components (A) and (B), in terms of ensuring the fluidity of the adhesive layer.

Curing Accelerator (D)

The adhesive composition can further contain a curing accelerator (D). Examples of the curing accelerator include, but are not limited to, cycloamidine compounds such as 1,8-diazabicyclo[5.4.0]undecene-7, 1,5-diazabicyclo[4.3.0]nonene-5, and 5,6-dibutylamino-1,8-diazabicyclo[5.4.0]undecene-7 and compounds having intramolecular polarization prepared by adding, to these compounds, a compound having a π-bond such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, or phenyl-1,4-benzoquinone, diazophenylmethane, and a phenol resin; tertiary amines such as benzyldimethylamine, triethanolamine, dimethylaminoethanol, and tris(dimethylaminomethyl)phenol and derivatives thereof; imidazoles such as 2-methylimidazole, 2-phenylimidazole, 2-phenyl-4-methylimidazole, and 2-heptadecylimidazole and derivatives thereof; organic phosphines such as tributylphosphine, methyldiphenylphosphine, triphenylphosphine, tris(4-methylphenyl)phosphine, diphenylphosphine, and phenylphosphine and phosphorus compounds having intramolecular polarization prepared by adding, to these phosphines, a compound having a π-bond such as maleic anhydride, a quinone compound as described above, diazophenylmethane, and a phenol resin; tetra-substituted phosphonium tetra-substituted borates such as tetraphenylphosphonium tetraphenylborate, tetraphenylphosphonium ethyltriphenylborate, and tetrabuthylphosphonium tetrabuthylborate; and tetraphenylboron salts such as 2-ethyl-4-methylimidazole tetraphenylborate and N-methylmorpholine tetraphenylborate and derivative thereof. These curing accelerators can be used independently or in combination of two or more. Especially, it is preferable to contain imidazoles as the curing accelerator.

Coupling Agent (E)

In addition, a coupling agent (E) can be added to the adhesive composition for improving the interface bonding between different materials. The coupling agent includes a silane-based coupling agent, a titanate-based coupling agent, and an aluminate coupling agent, and among them, a silane-based coupling agent is preferred.

Examples of the silane-based coupling agent include, but are not limited to, vinylsilanes such as vinyl trichlorosilane, vinyltris(β-methoxyethoxy)silane, vinyltriethoxysilane, and vinyltrimetoxysilane; methacryloyl silanes such as γ-methacryloxypropyltrimethoxysilane, γ-methacryloxypropylmethyldimethoxysilane, 3-methacryloxypropyltrimethoxysilane, and methyltri(methacryloyloxyethoxy)silane; epoxy group-containing silanes such as β-(3,4-epoxycyclohexyl)ethyltrimethoxysilane, γ-glycidoxypropyltrimetoxysilane, γ-glycidoxypropylmethyldimethoxysilane, γ-glycidoxypropylmethyldiethoxysilane, and methyltri(glycidyloxy)silane; aminosilanes such as N-β(aminoethyl)γ-aminopropyltrimethoxysilane, N-β(aminoethyl)-aminopropylmethyldimethoxysilane, γ-aminopropyltriethoxysilane, N-phenyl-γ-aminopropyltrimethoxysilane, 3-aminopropylmethyldiethoxysilane, 3-aminopropyltrimethoxysilane, 3-aminopropyl-tris(2-methoxy-ethoxy-ethoxy)silane, N-methyl-3-aminopropyltrimethoxysilane, triaminopropyl-trimethoxysilane, 3-4,5-dihydroimidazol-1-yl-propyltrimethoxysilane, and amyltrichlorosilane; mercaptosilanes such as γ-mercaptopropyltrimethoxysilane, γ-mercaptopropyltriethoxysilane, and 3-mercaptopropyl-methyldimethoxysilane; urea bond-containing silanes such as 3-ureidopropyltriethoxysilane and 3-ureidopropyltrimethoxysilane; isocyanate group-containing silanes such as trimethylsilyl isocyanate, dimethylsilyl isocyanate, methylsilyl triisocyanate, vinylsilyl triisocyanate, phenylsilyl triisocyanate, tetraisocyanatesilane, and ethoxysilane isocyanate; 3-chloropropyl-methyldimethoxysilane, 3-chloropropyl-dimethoxysilane, 3-cyanopropyl-triethoxysilane, hexamethyldisilazane, N,O-bis(trimethylsilyl)acetamide, methyltrimethoxysilane, methyltriethoxysilane, ethyltrichlorosilane, n-propyltrimethoxysilane, isobutyltrimethoxysilane, octyltriethoxysilane, phenyltrimethoxysilane, phenyltriethoxysilane, N-β(N-vinylbenzylaminoethyl)-γ-aminopropyltrimethoxysilane, octadecyldimethyl[3-(trimethoxysilyl)propyl]ammoniumchloride, γ-chloropropylmethyldichlorosilane, γ-chloropropylmethyldimethoxysilane, and γ-chloropropylmethyldiethoxysilane. These can be used independently or in combination of two or more.

When the adhesive composition according to the present embodiment contains the high-molecular weight component (A), the thermosetting component (B), the filler (C), the curing accelerator (D), and the coupling agent (B), it is preferred that the high-molecular weight component (A) be 50 to 80% by mass, the thermosetting component (B) be 15 to 40% by mass, the filler (C) be 3 to 10% by mass, the curing accelerator (D) be 0.05 to 0.15% by mass, and the coupling agent (E) be 0.5 to 2% by mass, based on 100% by mass of the total amount of the components (A) to (B).

If the high-molecular weight component (A) accounts for less than 50% by mass, the adhesive layer 10 will tend to be brittle, and if it accounts for more than 80% by mass, the fluidity of the adhesive layer 10 will tend to be reduced. Further, if the thermosetting component (B) accounts for less than 15% by mass, the curability of the adhesive layer 10 will be reduced, and if it accounts for more than 40% by mass, the adhesive layer 10 will tend to be brittle. Furthermore, if the filler (C) accounts for less than 3% by mass, the adhesive strength of the adhesive layer 10 will tend to be reduced, and if it accounts for more than 10% by mass, the fluidity of the adhesive layer 10 will tend to be reduced.

Examples of the base film 20 used include, but are not limited to, a polyester film, a polypropylene film, a polyethylene terephthalate film, a polyimide film, a polyetherimide film, a polyethernaphthalate film, and a methylpentene film.

These films may be subjected to surface treatment such as primer coating, UV treatment, corona discharge treatment, grinding treatment, and etching treatment. The thickness of the base film 20 is not particularly limited, but is arbitrarily selected according to the thickness of the adhesive layer 10 and the application of the bonding sheet 1.

The bonding sheet 1 of the present invention can be produced as follows, for example. First, the components of the adhesive composition as described above are mixed and kneaded in an organic solvent to prepare varnish, and a layer of the varnish can be formed on the base film 20 and dried by heating to obtain the bonding sheet 1. Alternatively, the base film 20 may be removed after drying the varnish layer to prepare a bonding sheet comprising only the adhesive layer 10.

The mixing and kneading can be performed by arbitrarily combining dispersion machines such as a conventional stirrer, a stone milling machine, a triple roll, and a ball mill. The conditions of the drying by heating are not particularly limited as long as these are conditions where the organic solvent used is sufficiently vaporized, but it is generally performed by heating at 60 to 200° C. for 0.1 to 90 minutes.

The organic solvent used for the preparation of the above varnish is not limited as long as it can uniformly dissolve, knead or disperse the components of the bonding sheet, and a conventionally known organic solvent can be used. Examples of such a solvent include amide-based solvents such as dimethylformamide, dimethylacetamide, and N-methylpyrrolidone; ketone-based solvents such as acetone, methyl ethyl ketone, and cyclohexanone; and hydrocarbon-based solvents such as toluene and xylene. It is preferred to use methyl ethyl ketone and cyclohexanone in that it has a high drying rate and a low cost.

The organic solvent is preferably used in the range that the residual volatile matter content in the adhesive layer 10 to be formed is 0 to 1.0% by mass on the basis of the total mass of the adhesive layer 10, and more preferably 0 to 0.5% by mass on the basis of the total mass of the adhesive layer 10 on the fear that the reliability is reduced by the foaming of the adhesive layer 10 or the like.

The adhesive layer 10 preferably has a melt viscosity at 100° C. before curing of 300 to 30000 Pas, more preferably 300 to 20000 Pa·s. If the melt viscosity is less than 300 Pa·s, the adhesive layer may overflow at the time of connection, and if it exceeds 30000 Pa·s, the embedding properties will tend to be insufficient.

The melt viscosity of the adhesive layer 10 can be measured using a rotating type viscoelasticity measuring apparatus (trade name “ARES-RDA”, manufactured by TA Instruments Japan, Inc.). Further, the adhesive strength of the adhesive layer 10 can be measured using a universal bond tester (trade name “Series 4000”, manufactured by Dage Precision Industries Ltd.).

Further, the thickness of the adhesive layer 10 is preferably 3 to 250 μm so that the unevenness of the wiring circuit of a substrate or a lower layer chip can be filled. If the thickness is less than 3 μm, the stress release effect and adhesiveness will tend to be reduced, and if it exceeds 250 μm, it will be less economical and the requirement of reduction in thickness of a semiconductor device may not be met. The thickness of the adhesive layer 10 is preferably 3 to 100 μm in terms of securing adhesiveness, more preferably 3 to 20 μm in that the thickness of a semiconductor device can be reduced.

The bonding sheet of the present invention has good gap-filling properties on the uneven surface of a substrate or a semiconductor chip. Accordingly, the bonding sheet can be used as a bonding sheet excellent in adhesion reliability in the step for bonding between a semiconductor chip and a substrate or between semiconductor chips in the production of a semiconductor device.

The load for filling the unevenness of a substrate or a semiconductor chip with a bonding sheet is selected arbitrarily. The wiring of a substrate and the unevenness of a semiconductor chip are preferably heated when the unevenness of the substrate or the semiconductor chip is filled with the bonding sheet. The heating method includes a method of bringing the substrate or the semiconductor chip having unevenness into contact with a previously heated hot plate.

### EXAMPLES

Hereinafter, the present invention will be described in detail with reference to Examples, but the present invention is not limited by these Examples.

High-Molecular Weight Component (A)

As the high-molecular weight component, components A1 to A3 each having the following composition were prepared. Note that the nitrile group content in the high-molecular weight component was determined by IR measurement and elementary analysis.

(IR Measurement)

The transmission IR spectrum was measured for the components A1 to A3 by a KBr tablet method, and the ordinate was expressed by absorbance. For the IR measurement, “FT-IR6300” (light source: a high-intensity ceramic light source, detector: DTATGS) manufactured by Jasco Corporation was used.

(Peak Height Near 2240 cm⁻¹ Derived from a Nitrile Group (P_{CN}))

The point where the peak of absorbance is the highest between the two points, 2270 cm⁻¹ and 2220 cm⁻¹, was defined as a peak point. The straight line between the two points, 2270 cm⁻¹ and 2220 cm⁻¹, was defined as a baseline, and the difference between the absorbance at the point on the baseline having the same wave number as the peak point and the absorbance at the peak point was defined as the peak height derived from a nitrile group (P_{CN}).

(Peak Height Near 1730 cm⁻¹ Derived from a Carbonyl Group (P_{CO}))

The point where the peak of absorbance is the highest between the two points, 1670 cm⁻¹ and 1860 cm⁻¹, was defined as a peak point. The straight line between the two points, 1670 cm⁻¹ and 1860 cm¹, was defined as a baseline, and the difference between the absorbance at the point on the baseline having the same wave number as the peak point and the absorbance at the peak point was defined as the peak height derived from a carbonyl group (P_{CO}).

(Elementary Analysis)

The components A1 to A3 was subjected to elementary analysis using a full automatic elementary analysis device “Vario EL” manufactured by Elementar to measure the nitrogen content.

A1: an epoxy group-containing acrylic random copolymer comprising 2.6% by mass of glycidyl methacrylate, 24.4% by mass of methyl methacrylate, 43% by mass of ethyl acrylate, 20% by mass of butyl acrylate, and 10% by mass of acrylonitrile (Mw: 500,000, Tg: 10° C., P_{CN}/P_{CO}: 0.03, nitrogen content: 2.6% by mass)

A2: an epoxy group-containing acrylic random copolymer comprising 2.4% by mass of glycidyl methacrylate, 43.5% by mass of methyl methacrylate, 18.3% by mass of ethyl acrylate, and 35.8% by mass of butyl acrylate (Mw: 500,000, Tg: 10° C., P_{CN}/P_{CO}: 0, nitrogen content: 0% by mass)

A3: an epoxy group-containing acrylic random copolymer comprising 3% by mass of glycidyl methacrylate, 29.25% by mass of ethyl acrylate, 38.15% by mass of butyl acrylate, and 29.6% by weight of acrylonitrile (Mw: 500,000, Tg: 10° C., P_{CN}/P_{CO}: 1, nitrogen content: 7.8% by mass)

Thermosetting Component (B)

Cresol novolac type epoxy resin: trade name “YDCN-700-10” manufactured by Tohto Kasei Co., Ltd., epoxy equivalent: 210, Tg: 75° C.

Phenol resin: trade name “Milex XLC-LL” manufactured by Mitsui Chemicals, Inc., hydroxyl equivalent: 175

Filler (C)

Silica: trade names “Aerosil 8972” manufactured by Nippon Aerosil Co., Ltd., average particle size: 0.016 μm

Curing Accelerator (D)

1-cyanoethyl-2-phenylimidazole Curezol: trade name “2PZ-CN” manufactured by Shikoku Chemicals Corporation

Coupling Agent (E)

γ-mercaptopropyltrimethoxysilane: trade name “NUC A-189” manufactured by Nippon Unicar Company Limited

γ-ureidopropyltriethoxysilane: trade name “NUC A-1160” manufactured by Nippon Unicar Company Limited

### Production of Bonding Sheet

### Example 1

The components were blended at the blending ratio (pails by mass) shown in Table 1 to prepare the adhesive composition. First, 11 parts by mass of “YDCN-700-10”, 9 parts by mass of “Milex XLC-LL”, 3 parts by mass of “Aerosil R972”, and cyclohexanone were mixed, and thereto was added a 17% by mass cyclohexanone solution of “A1” (76 parts by mass in terms of solids), and thereto were further added 0.02 part by mass of “Curezol 2PZ-CN”, 0.2 part by mass of “NUC A-189”, and 0.8 part by mass of “NUC A-1160”, followed by stirring and mixing until the resulting mixture is uniform. The resulting mixture was filtered with a filter of 100 meshes and vacuum deaerated to obtain the varnish of the adhesive composition.

The above varnish was applied onto a polyethylene terephthalate film, which is a base film and which has a thickness of 38 μm and has been subjected to release treatment, and dried by heating at 115° C. for 5 minutes to produce a bonding sheet in which an adhesive layer in the B-stage state (25 μm in thickness) was formed on the base film.

### Example 2

A bonding sheet was produced in the same manner as in Example 1 except that “A2” was used instead of “A1” which is a high-molecular weight component.

### Comparative Example 1

A bonding sheet was produced in the same manner as in Example 1 except that “A3” was used instead of “A1” which is a high-molecular weight component.

TABLE 1

| | | | | Comparative |
|---|---|---|---|---|
| | | Example | | Example |
| Items | | 1 | 2 | 1 |
| High-molecular weight | A1 | 76 | — | — |
| component (A) | A2 | — | 76 | — |
| | A3 | — | — | 76 |
| Thermosetting | YDCN-700-10 | 11 | 11 | 11 |
| component (B) | Milex XLC-LL | 9 | 9 | 9 |
| Filler (C) | R972 | 3 | 3 | 3 |
| Curing accelerator (D) | Curezol 2PZ-CN | 0.02 | 0.02 | 0.02 |
| Coupling agent (E) | NUC A-189 | 0.2 | 0.2 | 0.2 |
| | NUC A-1160 | 0.8 | 0.8 | 0.8 |

[Evaluation of the Bonding Sheet]

The properties of the bonding sheets produced in Examples 1 and 2 and Comparative Example 1 were evaluated as follows.

(1) Measurement of Melt Viscosity at 100° C.: Evaluation of the Embedding Properties for Embedding the Unevenness of a Substrate or a Semiconductor Chip

The melt viscosity of the adhesive layer of the bonding sheet was measured using a rotating type viscoelasticity measuring apparatus [ARES-RDA, manufactured by TA. Instruments Japan, Inc.].

After releasing the base film from the bonding sheet, five adhesive layers were bonded together at 70° C. to form a film having a film thickness of 125 μm, which was punched into a circle having a diameter of 8 mm. The produced circular film was pinched with two jigs having a diameter of 8 mm to produce a sample, which was measured for the melt viscosity at 100° C. under the following measurement conditions: frequency: 1 Hz, measurement start temperature: 35° C., and measurement finish temperature: 150° C., and heating rate: 5° C./min. The results are shown in Table 2.

(2) Insulation Reliability Test

A copper foil on a substrate for an electric corrosion test (Espanex (adhesive-free two-layer flexible copper-clad laminate manufactured by Nippon Steel Chemical Co., Ltd.)) was etched to form a comb pattern (without gold plating, line: 30 μm, space: 70 μm). Next, the base film was peeled from the bonding sheet which had been cut into a size of 5 mm×12 mm, and the resulting adhesive layer was temporarily compression-bonded on the above comb pattern using a compression-bonding machine under conditions of a temperature of 100° C. and a pressure of 2 kgf for 10 seconds and then further thermocompression-bonded under conditions of a temperature of 175° C. and a pressure of 17 kgf for 30 seconds.

The resulting bonded article was cured at 170° C. for 3 hours, and the resulting cured article was used as a sample for the insulation reliability test. The sample was placed in an accelerated life test apparatus (trade names “PL-422R8” manufactured by HIRAYAMA Manufacturing Corporation, conditions: 3.6 V bias/130° C./85%/200 hours) and measured for insulation resistance. As the evaluation method, the sample having an insulation resistance exceeding 10⁸Ω over 200 hours was rated as “A”, the sample having an insulation resistance in the range of 10⁶ to 10⁸Ω was rated as “B”, and the sample having an insulation resistance less than 10⁶Ω was rated as “C”. The results are shown in Table 2.

TABLE 2

| | | | Comparative |
|---|---|---|---|
| | Example | | Example |
| | 1 | 2 | 1 |
| High-molecular weight component (A) | A1 | A2 | A3 |
| Insulation reliability test | B | A | C |
| Melt viscosity at 100° C. [Pa · s] | 17000 | 12000 | 22000 |

As shown in Table 2, it is clear that insulation reliability is good in both Examples 1 and 2. Further the high-molecular weight component “A1” used in Example 1 has a reduced amount of nitrile which is lower than that in Comparative Example 1. Thus, it has been verified that the insulation reliability can be satisfied for a long time of 200 hours only by reducing the amount of nitrile. The high-molecular weight component “A2” which does not contain a nitrile group was used in Example 2, and it has been verified that, in Example 2, higher insulation reliability can be satisfied with stability for a long time than in Example 1.

In addition, as a result of measuring melt viscosity at 100° C. as an index of embedding properties, it was found that the melt viscosity was higher in the order of Example 2, Example 1, and Comparative Example 1, and it has been verified that this is the order of good embedding properties. This is probably because reduction in the nitrile group reduces the interaction between molecules to increase fluidity.

From the above results, it has been verified that the present invention can provide a bonding sheet which can satisfy both embedding properties and insulation properties important for improving the connection reliability of semiconductor devices.

### REFERENCE SIGNS LIST

1: bonding sheet, 10: adhesive layer, 20: base film.

1. A bonding sheet comprising:
an adhesive layer of an adhesive composition comprising a high-molecular weight component (A) and a thermosetting component (B) formed into a sheet, wherein
a ratio (P_{CN}/P_{CO}) of a peak height near 2240 cm⁻¹ derived from a nitrile group (P_{CN}) to a peak height near 1730 cm⁻¹ derived from a carbonyl group (P_{CO}) is 0.03 or less in an IR spectrum of the high-molecular weight component (A).

2. The bonding sheet according to claim 1, wherein a nitrogen content of the high-molecular weight component (A) is 4.0% by mass or less in accordance with elementary analysis.

3. The bonding sheet according to claim 1, wherein a melt viscosity at 100° C. of the adhesive layer is 300 to 30000 Pa·s and a thickness of the adhesive layer is 3 to 250 μm.

4. The bonding sheet according to claim 1, wherein the adhesive composition further comprises a filler (C), a curing accelerator (D), and a coupling agent (E).

5. The bonding sheet according to claim 2, wherein a melt viscosity at 100° C. of the adhesive layer is 300 to 30000 Pa·s and a thickness of the adhesive layer is 3 to 250 μm.

6. The bonding sheet according to claim 2, wherein the adhesive composition further comprises a filler (C), a curing accelerator (D), and a coupling agent (E).

7. The bonding sheet according to claim 3, wherein the adhesive composition further comprises a filler (C), a curing accelerator (D), and a coupling agent (E).

8. The bonding sheet according to claim 5, wherein the adhesive composition further comprises a filler (C), a curing accelerator (D), and a coupling agent (E).
